(19) United States
(12) Patent Application Publication
(10) Pub. No.: US 2015/0371219 A1
(43) Pub. Date: Dec. 24, 2015

(54) METHOD AND APPARATUS FOR USE IN IMAGE PROCESSING

(71) Applicant: PANELEVEN LIMITED, London (GB)

(72) Inventor: Pavle Ljujic, London (GB)

(21) Appl. No.: 14/766,580

(22) PCT Filed: Feb. 6, 2014
(86) PCT No.: PCT/GB2014/050350

§ 371 Date: Aug. 7, 2015

(30) Foreign Application Priority Data
Feb. 7, 2013 (GB) 1302186.0

(51) Int. Cl. G06Q 20/34; G06Q 40/02; G06T 11/60

(52) U.S. Cl. CPC G06Q 20/355; G06T 11/60; G06Q 40/02

(57) ABSTRACT

Disclosed herein is a method and corresponding apparatus for producing a personalised image for printing on a financial card. The method comprises receiving, through a user interface of a user device, instructions to manipulate an image for printing on a financial card, the image being stored on the user device. The method also comprises processing, at the user device, the image in accordance with the manipulation instructions. Furthermore, the method comprises sending the manipulated image from the user device to a service provider for printing the manipulated image onto a financial card. Other methods, apparatuses, computer program products, computer readable mediums and websites are disclosed.

### CROSS-REFERENCE TO RELATED APPLICATION(S)

This application claims priority to International Patent Application No. PCT/GB2014/050350 filed on Feb. 6, 2014 and entitled “Method and Apparatus for Use in Image Processing,” which claims priority to Great Britain App. 1302186.0 filed Feb. 7, 2013, the entirety of which are incorporated herein by this reference thereto.

### FIELD OF INVENTION

This disclosure relates to the field of image processing for manufacturing of personalised financial transaction cards. More specifically, but not exclusively, an image is personalised and processed at a user device and then transmitted to a remote server for later printing on a card.

### BACKGROUND TO THE INVENTION

There has been an increased consumer desire for personalised products, as can be seen by services offering personalised transaction cards, personalised mobile phone covers, and personalisation of other everyday items.

The personalisation of financial cards, including debit/credit cards and prepaid cards is a developing market. At present, systems exist for personalisation that allow for a user to select an image to be printed on a financial card. Such systems work by enabling the user to select an image, which is then stored on a server. The user is then able to manipulate the preview of the image on the card from a user device. Any manipulations are then transmitted from the user device to the server and the image is processed on the server in accordance with the manipulations. The processing required to produce the images for the cards places a great demand on the server, which is undesirable, at the very least for the service provider.

### SUMMARY OF INVENTION

Embodiments of the present invention attempt to mitigate at least some of the above-mentioned problems.

In accordance with an aspect of the invention there is provided a method for producing a personalised image for printing on a financial card. The method may comprise receiving, through a user interface of a user device, instructions to manipulate an image for printing on a financial card, the image being stored on the user device. The method may also comprise processing, at the user device, the image in accordance with the manipulation instructions. In addition, the method may comprise sending the manipulated image from the user device to a service provider for printing the manipulated image onto a financial card. This front-end based architecture reduces the burden on the service provider's server. In addition, since the processing is being carried out on the user device, fast processing is achieved thereby improving the user experience.

The method may further comprise receiving the image at the user device and storing the image on the user device prior to receiving manipulation instructions from the user. The image may be received from an image capture device associated with the user device. The image capture device may be a camera of the user device. The user device may be any suitable electronic device for performing the functionality disclosed herein.

The method may further comprise displaying the image on a display of the user device, wherein the display forms part of the user interface. When displayed, the user is therefore able to view the image for editing purposes and such like.

The method may further comprise sending, with the manipulated image, information identifying a user associated with the user device when sending the manipulated image from the user device to the service provider. The method may further comprise obtaining the information identifying the user. The information identifying the user may be obtained using a login process. The user may be identified from information stored on the user device. The information identifying the user may be obtained by scanning a financial card associated with the user. The scanning may be performed by a camera of the user device obtaining an image and a processor of the user device processing the image to identify information identifying the user. The information identifying the user may be identified from the scanned financial card using optical character recognition. For example, the optical character recognition may identify a PAN number as discussed in this document. Alternatively, the optical character recognition may recognise other details, such as the user's name, on the card. The information identifying the user may be obtained using near field communication NFC.

The method may further comprise sending information identifying the manipulations applied to the image to form the manipulated image with the manipulated image.

The image may be a frame of a video and the manipulations may be manipulations to the video.

The method may further comprise receiving the video prior to receiving the instructions to manipulate the image. The method may also further comprise analysing the quality of the video. Furthermore, the method may comprise informing the user of the quality of the video when the quality of the video is deemed to be below a threshold quality level. This threshold could be in terms of the number of pixels in the image. The step of sending the manipulated image from the user device to a service provider may further comprise sending the video with the image. In the step of sending the manipulated image from the user device to a service provider, the manipulated image may be a frame of the video and the video may be sent from the user device to the service provider. The frame of the video forming the manipulated image for printing on the financial card may be identified in metadata associated with the video. The user may select a video and image separately. The separately selected video and image may be transmitted to a server together.

The method may further comprise associating audio with the image at the user device. The method may also comprise sending the audio with the manipulated image to the service provider. The audio may be uploaded by the user. The audio may also be recorded by the user at the user device. The audio may also be associated with the image at the server.

In accordance with another aspect of the invention there is provided apparatus for producing a personalised image for printing on a financial card. The apparatus may be operable in use to perform the method described above, or anywhere in this document. The apparatus may be a user device.

According to yet another aspect of the invention apparatus is provided for creating a personalised financial card, the apparatus comprising a processor arranged to perform any method as described above or anywhere in this document. The apparatus may also comprise a printer arranged to print the manipulated image onto a card. The apparatus may also be arranged to print other information onto the card. The other information may be financial information. The other information may be information identifying the user. The apparatus may further comprise a communication unit arranged to obtain information associated with the user for printing onto the card. The apparatus may obtain the information associated with the user from a server, such as a card issuer's server or a service provider's server.

In accordance with another aspect of the invention there is provided a method for managing the production of a personalised financial card. The method may comprise providing, from a server associated with a service provider, computer operable instructions to a user device, the computer operable instructions arranged to enable a personalised financial card to be designed at the user device. The method may also comprise receiving, at the server associated with the service provider, an image for printing on a personalised financial card from the user device. Furthermore, the method may comprise storing the manipulated image at the server.

The computer operable instructions provided to the user device may be arranged to instruct the user device to perform any of the various methods described above.

The method may further comprise receiving, at the server associated with the service provider, a request to access a financial card personalisation website hosted by the service provider, and providing access to the website responsive to receipt of the request, wherein the website includes the computer operable instructions. The service provider may be operated by the card issuer and therefore the request may be received at and processed by the card issuer. Alternatively, the request may also be received at a card issuer website and forwarded onto a service provider arranged to provide the card personalisation process for the card issuer. The method may further comprise a method for determining the browser supported by the user device prior to providing the user with access to a website. The user is then provided with access to a website with functionality suitable for the browser. This browser determination may be performed in any way as discussed in this document.

The method may further comprise transmitting, from the server to a printing facility for a personalised financial card, the manipulated image along with a unique reference identifying a user associated with the manipulated image, wherein the printing facility may identify, from the unique reference, information associated with the user for printing on the personalised financial card. The unique reference may be used as the file name for the manipulated image for transmission to the printing facility. The service provider may obtain the unique reference from a card issuer. The service provider may create the unique reference and transmit the unique reference to a card issuer. The financial card may be a financial transaction card and the card issuer is a bank.

The printing facility may obtain the information associated with the user for printing on the personalised financial card from the unique reference in accordance with information received at the printing facility. The information received at the printing facility for obtaining the information associated with the user for printing on the personalised financial card from the unique reference may be a conversion tool for converting the unique reference into the information associated with the user.

The manipulated image may be converted to a card personalisation form prior to being transmitted from the service provider to a card issuer, the card personalisation form providing the manipulated image in a format for inclusion of the manipulated image within a card personalisation file. The card personalisation form may be a binary data stream. The card personalisation form may be a URL providing a means for obtaining the image from a stored location.

The service provider may associate media content with the manipulated image stored in the server. The media content may be arranged to be accessible to a device responsive to a request from a device including an identification associated with the manipulated image. The device may be a device of a user associated with the card. For example, the user may be a recipient of a gift card and the user is obtaining the media content.

The media content may be an image, a video, and/or audio.

The media content may be supplied to the service provider by a card issuer.

According to another aspect of the invention a server is provided for managing the production of a personalised financial card. The server may be arranged to perform the method described above or as described herein.

In accordance with another aspect of the invention a method is provided for managing processing of a personalised financial card. The method may comprise receiving, at a server of a personalised financial card service provider, a request from a user device to access a financial card personalisation website hosted by the server. The method may also comprise determining, from the received request, the Internet browser being used by the user device from which the request was sent. Furthermore, the method may comprise determining whether the determined Internet browser associated with the user device provides functionality capable of instructing the user device to process an image in accordance with manipulations input by a user at the user device. The method may also comprise providing access to a website hosted by the server that enables the image to be processed on the user device, if the browser provides functionality capable of instructing the user device to process the image. The method may also comprise providing access to a website hosted by the server that enables the user to select manipulations to be made to the image and sends these manipulations to the server for processing, if the browser does not provide functionality capable of instructing the user device to process the image. This method therefore allows for the system provide the most appropriate and therefore efficient functionality to the user device depending on the functionality provided by the browser associated with the user device.

The method may further comprise determining whether the Internet browser is capable of instructing the user device to process the image by comparing the determined Internet browser with a database listing Internet browsers capable of instructing a user device to process an image.

If the browser does not provide functionality capable of instructing the user device to process the image, the method may further comprise receiving, from the user device, an image selected by the user, receiving, from the user device, information indicative of manipulations to be made to the image, and manipulating the image at the server in accordance with the received manipulations. This may be called a back-end based processing system.

When the browser provides functionality capable of instructing the user device to process the image, the website that the user device is provided with access to may be arranged to instruct a computer to perform any of the user device based image processing methods described herein.

The internet browser type may be determined by a PHP get_browser method or JavaScript navigator object.

According to another aspect of the invention a server for managing processing of a personalised financial card is provided. The server may be arranged to perform any of the methods for determining a browser as described herein.

According to another aspect of the invention a method for providing additional media content associated with a financial card is provided. The method may comprise identifying a financial card at a user device, obtaining, at the user device, additional media content associated with the financial card from a remote server, and outputting the additional media content through an output of the user device. The outputting of the media content may involve rendering the content and outputting it through a suitable user interface output device, such as a screen or a speaker. The media content may be one or more of one or more images, one or more videos, and/or one or more audio files.

The financial card may be identified using near field communication. The card and user device may therefore have near field communication capabilities.

The financial card may be identified by analysing an image received from an image capture device of the user device. The financial card may be identified by identifying an image on the financial card in the image received from the image capture device. The financial card may therefore be in a field of view of an image capture device. The image on the financial card may be a card background image. The image on the financial card may be a PAN number. The PAN may be identified using optical character recognition. The optical character recognition procedure may be provided as discussed herein. The image on the card may be a machine readable device, MRD. The MRD may be hidden within a card background image.

The financial card may be identified by identifying patterns in the received images and comparing the identified patterns with patterns stored in memory indicative of features of a financial card. Information identifying the financial card may be obtained from a result of the comparison.

The additional media may be obtained by sending information identifying the financial card to a server and receiving the additional media responsively.

The additional media content may be audio and the outputting of the media content may comprise playing the audio through a speaker of the user device.

The additional media content may comprise an image and the outputting of the media content may comprise displaying the image on a display of the user device.

The obtained additional image may be a video or forms a part of a video. The method may further comprise receiving an image from an image capture device of the user device, the image capture device having a field of view. The method may further comprise determining a position of the financial card in the image received from the image capture device. Furthermore, the method may comprise overlaying the obtained image on the image received from the image capture device to create an augmented reality image, the overlaid image being positioned according to the determined position of the financial card. The method may further comprise displaying the augmented reality image on the display. This therefore provides an augmented reality functionality and an improved user experience.

The overlaid additional image may be positioned at the determined position of the financial card in the image received from the image capture device in real time. The position of the financial card may be determined in accordance with a template identifying an outline shape of the financial card. The position of the financial card may be determined from the position of the image on the financial card in the received image. The position of the financial card may be determined using edge recognition. The position of the financial card is determined using AR SDK.

According to another aspect of the invention there is provided apparatus for providing additional media content associated with a financial card, the apparatus operable in use to perform any of the methods for providing additional media content associated with a financial card, such as those relating to augmented reality. The apparatus may be a user device.

According to a further aspect of the invention there is provided a method for managing the providing of additional media content associated with a financial card, the method comprising providing, from a server associated with a service provider, computer operable instructions to a user device, the computer operable instructions for instructing the user device to perform any of the methods for providing additional media content associated with a financial card, such as those relating to augmented reality.

The method may further comprise receiving information identifying a financial card from the user device. The method may also comprise identifying an additional image associated with the identified financial card. Furthermore, the method may comprise sending the additional image information to the user device.

According to another aspect of the invention there is provided a server for managing the providing of additional media content associated with a financial card, the server arranged to perform the method described above and herein.

In accordance with another aspect of the invention there is provided a method for user verification. The method may comprise receiving an image from an image capture device having a field of view. The method may further comprise analysing the image received from the image capture device to identify a Personal Account Number, PAN, associated with a financial transaction card within the field of view of the image capture device. The method may also comprise determining a type of card from the PAN. In addition, the method may comprise obtaining information indicative of characterising features associated with the determined type of card. The method may also comprise analysing the image received from the image capture device to identify the presence of at least one characterising feature associated with the type of card on the financial transaction card within the field of view of the image capture device. The method may also comprise outputting a positive verification signal if the characterising features are identified.

The type of card may be determined from the PAN. The identifying the presence of the at least one characterising feature may comprise determining whether an object matching one of the at least one characterising feature is on the card and determining whether the object matching the at least one characterising feature is in the correct position on the card.

The at least one characterising feature may include one or more of a name, a valid from date, an expiry date, and a logo.

The method may further comprise logging into a system responsive to the positive verification signal.

The method may also further comprise using the identified PAN for a payment responsive to a positive verification signal. The PAN may be identified using an optical character recognition, OCR, scheme. The OCR scheme may be a matrix matching technique for character recognition that comprises determining one or more patterns in the received image and comparing the one or more determined patterns with patterns stored in memory.

According to another aspect of the invention there is provided an apparatus operable in use to perform any of the verification methods described herein.

In accordance with yet another aspect of the invention there is provided a computer program product operable, in use, to instruct a computer to perform any method as described above or anywhere in this document.

In accordance with a further aspect of the invention there is provided a computer readable medium arranged to be utilised by a computer to instruct a computer to perform any method as described above or anywhere in this document.

According to another aspect of the invention there is provided a website accessible by a computer and operable, in use, to instruct a computer to perform any method as described above or anywhere in this document.

According to an aspect of the invention an apparatus is provided for producing a personalised image for printing on a financial card, the apparatus comprising a memory arranged to store an image for printing on a financial card. The apparatus also comprises a user interface arranged to receive instructions to manipulate the image for printing on a financial card. Furthermore, the apparatus comprises a processor integrated into the user device and arranged to process the image in accordance with the manipulation instructions. The apparatus also comprises a communications unit arranged to send the manipulated image to a service provider for printing the manipulated image onto a financial card.

Embodiments of the invention relate to a card designer tool that allow users to upload their own images and videos and/or choose from a gallery of images and videos, manipulate the image and/or video, and reproduce the manipulated images/videos on a card. The card may be a plastic card. For example, the card may be a financial card including prepaid cards such as gift cards.

In embodiments of the invention a card designer functionality is provided that allows end users to produce “standard” personalised photo cards, personalised special shape cards, for example a plastic card in the shape of a car, hair comb, or any other suitable shape, and/or personalised video cards using augmented reality (AR). The system may allow users to save several images/videos along with manipulations applied to the images/videos.

Embodiments of the invention provide a user interface and image/video processing functionality through an end user's browser on any desktop system, at a standalone kiosk or on a mobile device via a downloadable native application or through a mobile version of a web application card designer optimized for mobile devices.

In embodiments of the invention implemented on mobile devices, the card designer and processing functionality may be provided using the native manufacturer development kits (SDKs) like Objective C for mobile iOS, Java for Android platforms and C# for Windows mobile operating systems. Furthermore, regarding the desktop operating systems, the functionality may be based on the HTML5 standard and JavaScript library which allows for greater cross-browser compatibility. Use of this technology may extend the usage of the system of embodiments of the invention to browsers used on mobile operating systems.

Embodiments of the invention are arranged to work seamlessly on any device providing same service throughout. The visual design of the application may vary depending on the device in order to optimise user experience.

Embodiments of the invention provide a card design and processing system arranged for the design and processing of financial cards such as credit cards, debit cards, and charge cards, in addition to the design and processing of prepaid and stored value cards, such as gift cards.

In embodiments of the invention, a front-end system is provided that enables the creation of a personalised card. The front-end created personalised card may be sent to a back end system for managing of the final processing, such as manufacturing. The back end system may consist of an administration system for orders and product manipulation, e.g. for creation of products, image and video approvals, etc. The back end may also enable for communication with a card issuer, such as a bank, via an Application Programming Interface (API) that can be provided by a card issuer or by the service provider. The system may be designed to support communication and operation with more than one card issuer if implemented as standalone system.

Embodiments of the invention provide a front-end based system, whereby all end user requested manipulations of the uploaded image are performed at the front-end, i.e. at the user device. The final image or video saved at the user device may then be sent to a host server where the image/video is stored alongside manipulations for later reusability of design.

Embodiments of the invention determine whether image processing including image manipulations should be carried out at a user device or at a server controlled by manipulation instructions provided from a user device. Such embodiments firstly examine the browser version used by the user. Subject to the version of the browser, the system may choose whether to implement a front-end based system or a front/back end architecture. Newer browsers such as Internet Explorer (IE) version 9 and upwards may use a front-end only system while older browsers such as IE version 8 and downwards may use a front/back end architecture.

An advantage of using a front-end based system is the speed of processing of manipulations to the image when compared to a system in which the processing is carried out at a remote server. Furthermore, a front-end system reduces the server loads and thereby the cost of processing for the host as there is no need for powerful and expensive servers at the back end.

A front-end based system may utilise HTML 5 and JavaScript.

Some embodiments of the invention provide a financial transaction card personalisation system. Alternative embodiments of the invention provide a prepaid and/or stored value card personalisation system. Other embodiments of the invention provide an integrated financial transaction card and pre-paid financial card personalisation system.

Embodiments of the invention allow for requirements of the card issuer to be incorporated into the design process. For example, predefined positions of the issuer's fixed elements on a card may be incorporated into issuer's native application or website with or without a need for login (open or closed system).

### BRIEF DESCRIPTION OF THE DRAWINGS

Exemplary embodiments of the invention shall now be described with reference to the drawings in which:

FIG. 1 illustrates a system for processing of personalised financial cards according to an embodiment of the invention;

FIG. 2 shows the process by which a personalised card may be ordered when using the system of FIG. 1;

FIG. 3 shows a login screen for a card personalisation website;

FIG. 4 shows the processing of the order for a personalised financial transaction card;

FIG. 5 shows the process for instant issuance of such an order;

FIG. 6 shows the processing of the order for a personalised pre-paid financial card;

FIG. 7 shows the process for designing a personalised financial card;

FIG. 8 shows a card selection screen for a card personalisation website;

FIG. 9 shows an image selection screen for a card personalisation website;

FIG. 10 shows an image manipulation screen for a card personalisation website;

FIG. 11 shows a text editing screen for a card personalisation app;

FIG. 12 shows a video card personalisation screen for a card personalisation website;

FIG. 13 shows a card (AR) preview functionality;

FIG. 14 shows the process of providing augmented reality at a financial card; and

FIG. 15 shows an OCR login screen for a card personalisation website.

Throughout the description and the drawings, like reference numerals refer to like parts.

### DETAILED DESCRIPTION

### System Overview

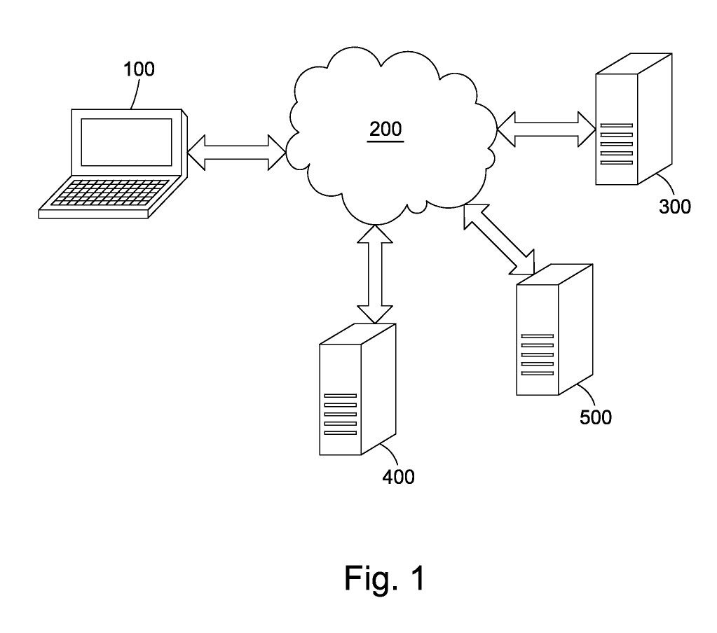

FIG. 1 illustrates a system according to an embodiment of the invention for processing of personalised financial cards. A financial card is either a financial transaction card or a pre-paid card. Financial transaction cards include credit cards, debit cards, charge cards and store cards. In contrast, pre-paid cards include gift cards, stored value cards such as travel cards, e.g. London's Oyster card, or loyalty cards in which rather than money, points, which have some financial value to the user, are stored on the card.

In the system of FIG. 1, a user is able to create an image that they want printed on the card at a user device 100. The user device includes at least a processor arranged to perform the processing for creation of the image, a memory used to store the image being processed, and a communications unit for communicating with other devices and across one or more networks. The user device 100 is depicted as a laptop computer in FIG. 1, but it will be appreciated that the user device could be any computing device capable of performing such processing such as a desktop computer, mobile smart phone, tablet, PDA, or such like. The user is therefore able to edit, manipulate and process the image on the user device.

Once the user has created the image that they would like printed on the card this image is transmitted across the network, which in this case is the Internet, to a server 300 of a service provider. The service provider server 300 then stores the image in its memory. The image is linked to other information stored in the server identifying the user of the user device 100. A card personalisation bureau (CPB) server 400 is then able to obtain the image to produce the card.

If the financial card is a financial transaction card, such as a credit card, debit card, charge card or store card, then one or more of the service provider and the CPB will liaise with a server 500 associated with a card issuer, such as a bank issuing the financial card, in order to verify and/or obtain the user information (such as name and/or account information) required for creation of the financial transaction card. If the financial card is a gift card or such like, then such stringent financial verification is not required.

It will be appreciated that FIG. 1 is a simplified overview of the system. The system shall now be described in more detail.

### Card Ordering and Processing Procedure

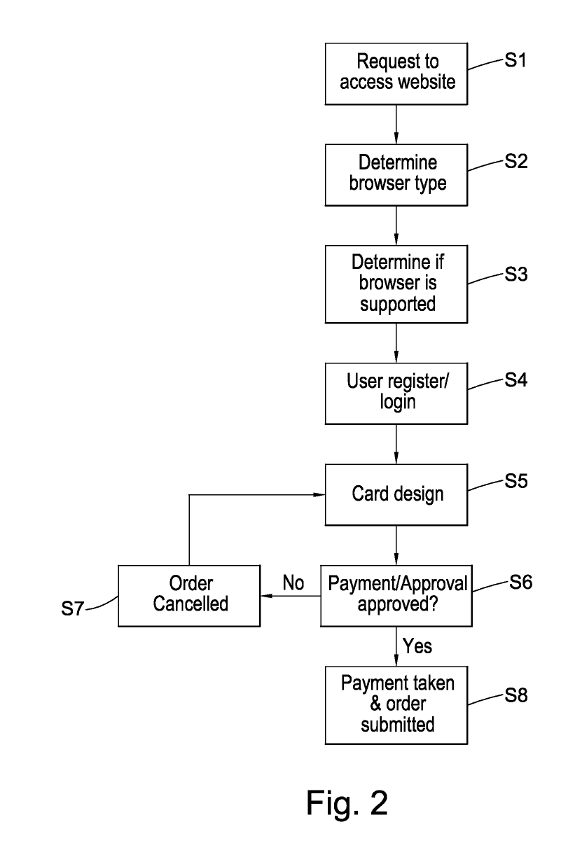

The process by which a personalised card is ordered shall now be discussed with reference to FIG. 2.

In order to create a personalised card, the user firstly requests access to the service provider's website via the user device 100 as shown by step S1 in FIG. 2. In alternative systems, the user may download a program, native application, or app onto their device, which is then used for card personalisation on the user device. It will be appreciated that the user may access the service provider's functionality through a card issuer's website, which will redirect the user to the functionality provided by the service provider, or the card issuer may provide the service provider's functionality from their own system. When the user's request to access the website is received, the system is able to determine the type of card creation system that the user's browser and computer architecture is able to support (step S2). This is achieved because the request to access the website sent by the user device 100 will include an identification of the browser. The user device has already detected the browser type for inclusion in the access request sent to the service provider. The internet browser type may be detected by the user device using techniques such as JavaScript navigator object. If the server detects the browser type directly then a PHP get_browser method could be utilized.

Browsers that do support the functionality of a front-end architecture, in which most of card processing, and more specifically the image processing, is performed on the user device, use the front-end architecture. The front-end architecture is provided using latest Jquery, JavaScript and Canvas API from HTML version 5. Hence, browsers with such capabilities will use a front-end architecture. However, those browsers that do not support such a front-end architecture utilise a back-end based architecture in which the user device communicates with the service provider's server to manipulate the image, which is stored on the service provider's server. In general, with a back-end architecture, the manipulations to be made to the image are stored on the user device and then sent to the service provider's server 300 as a text file in order for the image to be processed in accordance with manipulation instructions received from the user device 100.

It is generally preferable to utilize the front-end architecture because by processing the image to be printed on the card on the client side without any involvement of the service provider server 300, server time demand is reduced, the service provider requires less server processing power capabilities.

Once the server has identified what browser is requesting access to the website, for example from the browser information included in the access request, the server firstly looks up in a database of browsers whether or not the browser supports the front-end architecture. Dependent on whether or not the browser provides support, the browser provides the user with access to a web page having appropriate functionality for use with either frontend or front/backend based architecture (step S3).

Depending on the detected browser version, the system may inform the user about deficiencies their browser has. For example, Apple's Safari supports WebGL but this functionality is disabled by default. In such circumstances the user is prompted to enable WebGL or download another browser in order to provide the best end-user experience.

Once the user has accessed the web page for creating the personalised financial card the user is then able to log-in to the system, if they are registered with the system (step S4). If the user is not already registered to use the system, they will need to register before logging in. Furthermore, in some systems, it may be possible to design the personalised card, or even start designing the personalised card, and then perform the login/registration process of after creation.

When registering, the user can create a user account profile. The user profile is stored on the service provider server. The user information may include one or more of the user's first name, surname, address, DOB, and a log-in password. Depending on the system, various other security provisions could be provided for authentication purposes.

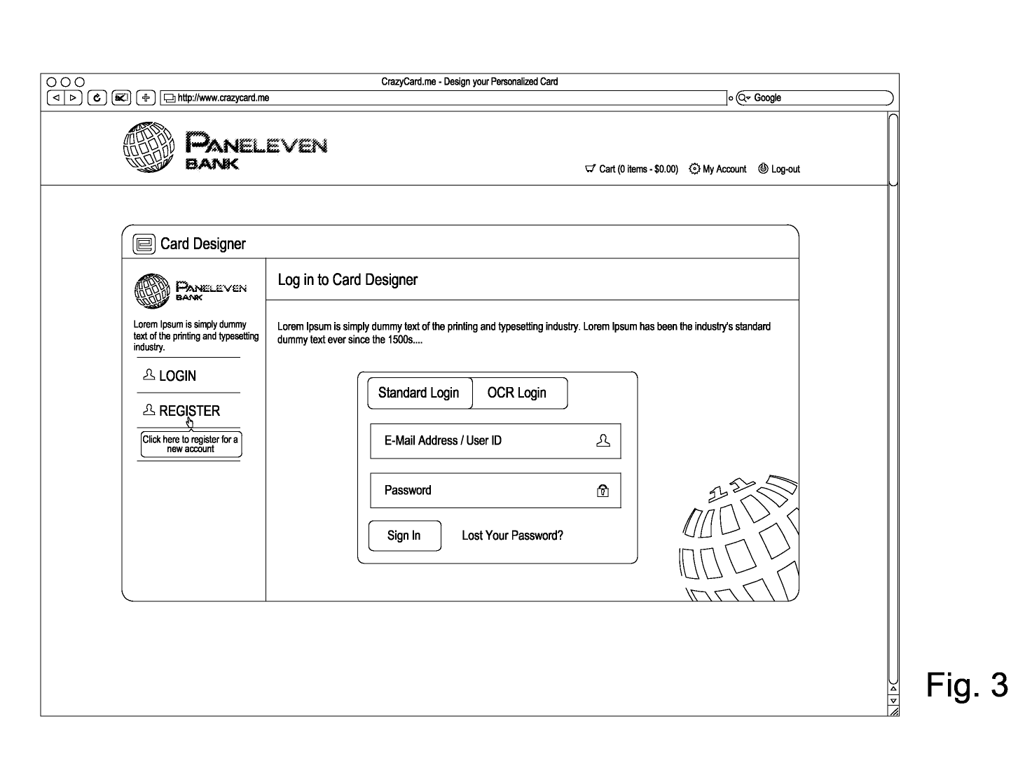

Once registered, the user is able to log into the system through a user login landing page as shown in FIG. 3, where the user is required to input the necessary security information. In FIG. 3, this login information is a username and password, however, it will be appreciated that other login information could be utilised. If the service provider's system is incorporated into an issuer's web page, such as a bank's web page, the login procedure can be connected to the bank's database and therefore the bank's server 500. In such circumstances the login details may be the same as for any other part of the bank's online banking services. In this case, the login and security provisions are the responsibility of the bank or issuer and if the login is successful, an Application Programming Interface (API) call is made to the service provider's system for identifying the user. The user is then passed to the next step, the card designer screen.

Once the user has successfully passed authentication, the user is presented with a card designer module where the user is able to design their card at step S5. The design of the personalisation card will be described in detail later in this document.

When the user has finished creating their card, the user then approves the design of the card. They are then taken to a payment screen in which they pay for the service and submit their order (step S6).

The payment step involves the use of a 3rd party payment gateway such as WorldPay and PayPal. However, the service provider or issuer, e.g. bank, may use their own payment gateway. Furthermore, in alternative systems where the user is personalising a card on the card issuer's website and the card issuer is the user's bank then the payment can be taken directly from the user's bank account. When using a 3rd part payment gateway, the payment is not taken as cleared funds but secured and taken following the approval of the user personalised image. The actual transaction of funds process is done by what is known in the art as a “Cardholder Not Present” process and by an additional security check provided by the card schemes, such as Verified by Visa and MasterCard Secure Code, if required. The user can also store their payment requirements within the system.

After the payment is submitted, the user waits for the image/order approval procedure to take place. The image is reviewed by the service provider and/or bank to ensure that the content of the image is not inappropriate for printing on the card, this may include checking for obscene images such as those of a sexual or violent nature. If the image fails the compliance test, the user is informed through a communications means, such as SMS, Push Message, or email and is then invited to redesign the card and the order is cancelled (step S7). If the image is approved, the payment is taken and the order submitted (step S8).

When checking out, the user is also able to select fast track approval, which means that the order goes straight to the top of each necessary processing queue. The fast tracking is achieved by sending notifications (SMS, Email, Push message) to the authorising personnel in charge of image/video approval.

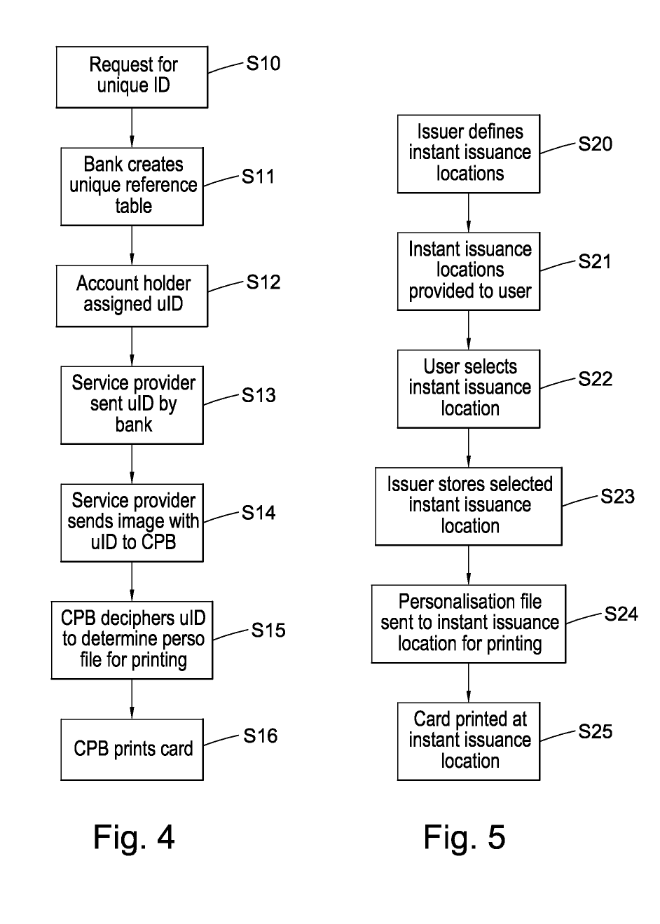

Now that the card is ordered, the order is processed as discussed with respect to FIG. 4. The card ordering process differs for financial transaction cards when compared to pre-paid cards and therefore the two procedures will be considered separately, with financial transaction cards considered first.

Banks have used CPB for many years for card manufacturing and therefore the processes involved are well known. However, the introduction of a third party card personalisation provider adds an additional complexity to the system. Hence, the steps and processes that take place for the image created by the user to be printed on a card shall now be discussed.

Due to the importance of financial data security, card issuers cannot and/or will not usually share account holder information with 3rd parties. For this reason instead of identifying the user and user image in accordance with their financial information, an alternative identification mechanism is provided for linking the user of the card personalisation service provider's service to an account held with their bank and in particular to a card perso file for that user, which is data required for a financial transaction card such as the magnetic stripe, chip, and emboss/indent data. This alternative identification mechanism is discussed below.

In order to provide the alternative identification mechanism the bank will create a reference table, which is stored on the bank server 500 (step S11). In the reference table, the user's account number is given a unique reference for 3rd parties to use. For example, bank account number 123456 is “translated” into a 3rd party reference ABCDEF. This 3rd party reference (i.e. ABCDEF) becomes the unique identifier (uID) for that account holder (step S12). The bank then stores the 3rd party reference against the user's account number in the reference table.

This process of creating 3rd party references is (usually) done by the bank in a secure environment, and (usually) involves some sort of a cipher. In order for the reference table model to work, the bank must exchange either the reference table or the algorithm used in the creation of the reference table with the CPB because the CPB must know to which card perso file, the 3rd party reference corresponds.

In practice, the reference table model for alternative identification of a user and their bank details works in the following way:

The user completes the processing of their image and submits the image and associated information such as details regarding the card to be manufactured to the service provider server 300 via the bank's website, which the user is currently logged into;

The service provider server 300 then submits a request to the bank's server 500 for a unique reference for the user (step S10).

The Bank then generates a 3rd party unique reference uID for the user (step S12). The uID can be exchanged with 3rd parties at various stages of the personalised card processing system process subject to system (both bank and 3rd party service provider) set-up. In this case the bank sends the uID to the service provider (step S13).

The 3rd party then uses the uID as a reference in its systems (i.e. it stores the user defined picture as-for example—ABCDEF.jpg).

Following approval of image by the service provider and/or bank for use on the card, the service provider sends the picture to the CPB as, for example, ABCDEF.jpg (step S14).

The CPB then receives or collects the image file from the service provider and deciphers the uID utilising information provided to the CPB by the bank in order to determine which card perso file the image is associated with (step S15). For example, the CPB:

Uses the reference table or algorithm to work out that ABCDEF is in fact account number 123456, and then uses this information to determine that account number 123456 corresponds to a particular card perso file. The CPB is able to do this because the account number is part of the card perso file. The CPB then prints ABCDEF.jpg on the card and personalises the card with the other relevant information such as the emboss data and magstripe data (step S16).

While in the above system the uIDs are generated by the bank, in alternative systems the uID is created by the service provider. Such systems are advantageous in that some banks may not want the additional processing and security burden of generating and managing third party reference numbers. In such systems the service provider server is arranged to generate a uID at the point that it receives the image from the user device and the service provider sends this uID to the bank. The CPB then receives the uID from the service provider embedded with the image, and obtains the means necessary to translate the uID to the perso file from the bank.

In other alternative systems the service provider both generates the uIDs and sends the uIDs to the Bank in a card perso file “friendly” format. The uID can be generated on the fly, or prepared in advance and activated once demanded. Once the user logs in, the application asks for the uID generated from the service provider. The uID is provided to the bank at this point in such a way that the bank can incorporate the uID into the card perso file during the card perso file formation. This process assumes that the bank Card Management System (CMS) will have additional data elements, which will be similar to the emboss data and include the uID. This additional data will not interfere with processing the CMS output file in any of the processes not specifically related to the personalization. The process of such embodiments eliminates the need for the bank to share a reference table (or an algorithm) with the CPB, as the CPB will have the uID during the parsing process of the card perso file and will be able to automatically link it to the image supplied by the service provider under the same uID.

In a further alternative system, instead of generating a uID, the service provider sends the bank the user defined image in such a way that the bank can incorporate it into the card perso file during the card perso file formation. This can be done by converting the user defined image into binary code. The image conversion into binary code may be different depending on the personalization system type within the CPB and supporting method of printing the binary images. Converting an image to binary allows you to easily store it and pass values, without worrying about the encoding being affected. The code can either be saved as a function to be used as part of a larger program, or as a stand-alone file, if you only need to run an operation once. The image conversion into binary code may be different depending on the personalization system type within the CPB and supporting method of printing the binary images. The difference will consist of adding additional elements such as the image length data, or any other element specific to the CPB system and personalization machine.

In another alternative system, the service provider includes and sends a URL path in a card perso file “friendly” format for inclusion in the card perso file where the image is located on the service provider's server 300 or on the CPB's server 400. This URL path is then provided with the card perso file from the bank so that the CPB can retrieve the image quickly and easily when they receive the card perso file which is parsed through the system.

The system also enables for an instant issuing process to take place. Instant issuance is a method of sending the personalization record directly to a branch of the issuer associated with the user for printing. Instant issuance works as shown by FIG. 5 and discussed below:
A. The issuer, such as the bank, defines a set of locations marked as instant issuance locations, i.e. those branches able to offer card personalisation printing services. A. The issuer provides each of these locations with a unique identifier. Additional information may be associated with each location, for example geo-location coordinates used for visual representation of the location on an online map, which can be used during the card ordering procedure (step S20).
B. The instant issuance locations are provided by the service provider to the user (step S21). For example, these instant issuance locations may be provided by the issuer to the service provider and stored on the service provider's server 300. Hence, when a user places an order and selects to use a specific instant issuance location, the unique identifier for the selected instant issuance location is stored along with other order details used for the card ordering procedure (step S22).
C. Once the order is made inside the service provider's system, and order details are sent or retrieved depending on the system configuration, the issuer sets up the personalization record to “understand” the instant issuance location (step S23). In other words, for example, the service provider sends number 8 under field name IIL (IIL=8). The meaning of the field IIL=8 will have no connection to the issuer in a standard system setup. The issuer must define the meaning of the field IIL in its own system and the value will represent the reference to the location itself, or the branch name.
D. Once the issuer has defined the meaning of the field IIL, the relevant personalization file is sent to the location that corresponds to the value of that field. The method for sending of the data is determined by the issuer not the service provider because the communication is then an internal communication within the issuer's system (step S24).
E. The issuer's instant issuance location will then receive the necessary information for printing the card and print the card accordingly (step S25). The user is then informed that the card is ready for collection from their chosen instant issuance location.

Due to the vast differences in how financial transaction cards are issued and managed by card issuers compared to prepaid cards the procedure used by the system for processing of prepaid cards is different to that described above. These differences shall now be discussed.

With prepaid cards, i.e. cards for which money or points representative of money is prepaid onto such as gift cards, travel cards or loyalty cards, the issuer of the card does not always know who the end user is, i.e. the recipient of the card may be “gifted” the card by a “giver”. Prepaid cards and stored value cards are cards on which the monetary value is preloaded. The term stored-value card means the funds and or data are metaphorically ‘physically’ stored on the card, in the form of binary-coded data. With prepaid cards the data is maintained on computers affiliated with the card issuer. This differs from a debit card for which money is on deposit with an issuer against an external account associated with the card. Due to anti-money laundering regulations branded prepaid or stored value cards require the purchaser of the prepaid or stored value card or the “giver” (in case of gift cards) to provide personal details which are stored in a secure system. Currently this is not the case with certain types of pre-paid cards such as closed loop gift cards like the iTunes card, which can be purchased for cash. Generally, the recipient or user of the card is anonymous.

For pre-paid cards, the value of the money stored on the card is accessed using a magnetic stripe embedded in the card; through a contactless interface using an antenna embedded in the card and a radio frequency transmitter located in the card reader on which the card number and/or funds is encoded using radio-frequency identification (RFID); barcode and/or another machine readable device (MRD) in which the card number is encoded into the MRD and printed on the card during the card personalisation process.

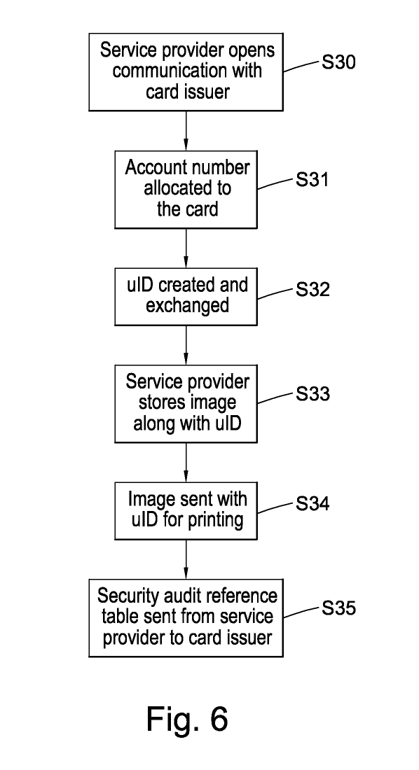

The process for a user ordering a pre-paid card differs from the above-described system for a financial transaction card as set-out below with reference to FIG. 6. This procedure effectively replaces that of FIG. 4.

The user completes their order and submits the personalised card information to the service provider, as discussed with respect to FIG. 2. Once the image is approved by the service provider, the service provider system opens communication with the card issuer through an API function (step S30). Since the card is prepaid card, which in most cases is a one-off card not linked to a particular financial account (unlike a financial transaction card), it is necessary to create and allocate an account number to the card. This allocation process works as follows:
a) An account number is allocated to the card (step 31) by either:
   i) creating an account number “on the fly” for the specific card; or
   ii) allocating a range of pre-generated account numbers for the service provider and the service provider simply takes one of the pre-allocated account numbers and assigns the account number to the card.
b) A uID is created and then exchanged (step S32). As with the financial transaction card system the uID could be created at either the service provider end or the card issuer end. The issuer then links the uID to its account number information and the service provider links the uID to the order/user.
c) The service provider system then stores the image/personalised card information in its server according to the generated and/or exchanged uID (step S33).
d) The service provider sends the image with the uID to either the Issuer or CPB for printing (step S34), as described in respect of the financial transaction card. The card shipping details can be:
   a. Sent to the CPB using the same uID as the image
   b. Sent to the Issuer using the same uID as the image and/or one of the alternative ways described in respect of the financial transaction card.
e) The service provider submits a security audit reference table to the card issuer (step S35). The security audit reference table lists card purchaser information, which is submitted by the purchaser during the purchase process, against the uIDs; for example John Smith purchased a £100 card for the uID ABCDE. This process allows the Issuer to comply with its legal obligation in respect of Anti-Money-Laundering regulation.

The various alternative procedures, such as use of binary code and a URL as discussed above in respect of the financial transaction cards could also be utilised for pre-paid cards. It will be appreciated that such information is incorporated in the data file sent to the CPB for printing.

For gift cards, multiple recipients of the same card may be selected. In such circumstances, the image information is sent from the user device with multiple recipient details. The recipient details are then stored in the service provider's server as a group order. However, in alternative embodiments, the user device may issue the multiple recipient order as multiple orders, thereby transmitting the image information multiple times across the network to the service provider with each associated recipient being attached to the image information.

Unlike the system described above for the financial transaction card, when designing the gift card, the system also provides some additional functionality. In particular, the user profile function allows for users to insert details about recipients of the gift card. This information can be inserted manually and/or be imported automatically from a mail account associated with the user and stored securely on the service provider server.

Loyalty cards can be considered the same as gift cards for the purpose of card personalisation as the only difference is that they store points rather than money. In any case, the points on loyalty cards are usually have a financial value to the user.

### Card Designing Functionality

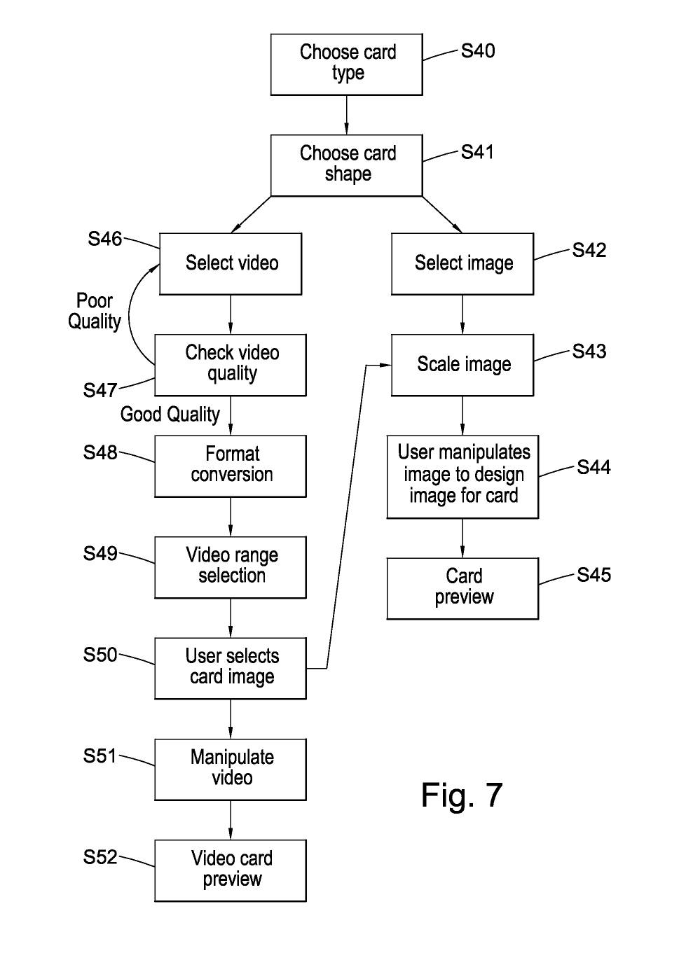

The functionality for designing the personalised card and the image shall be described with reference to FIG. 7.

Firstly, the user is able to select whether they wish to design a financial transaction card or a pre-paid card. It will be appreciated that in some embodiments of the invention this choice may not be provided. For example, if the system is provided via a bank's web page then it may only be able to obtain a financial transaction card, whereas if the system is provided via a shopping stores website then it may only be possible to obtain a pre-paid card such as a gift card.

The card design procedure is substantially the same for both financial transaction cards as it is for pre-paid cards. It can therefore be assumed that the following description applies to both types of card. The differences between the design procedure for both card types will be identified when appropriate.

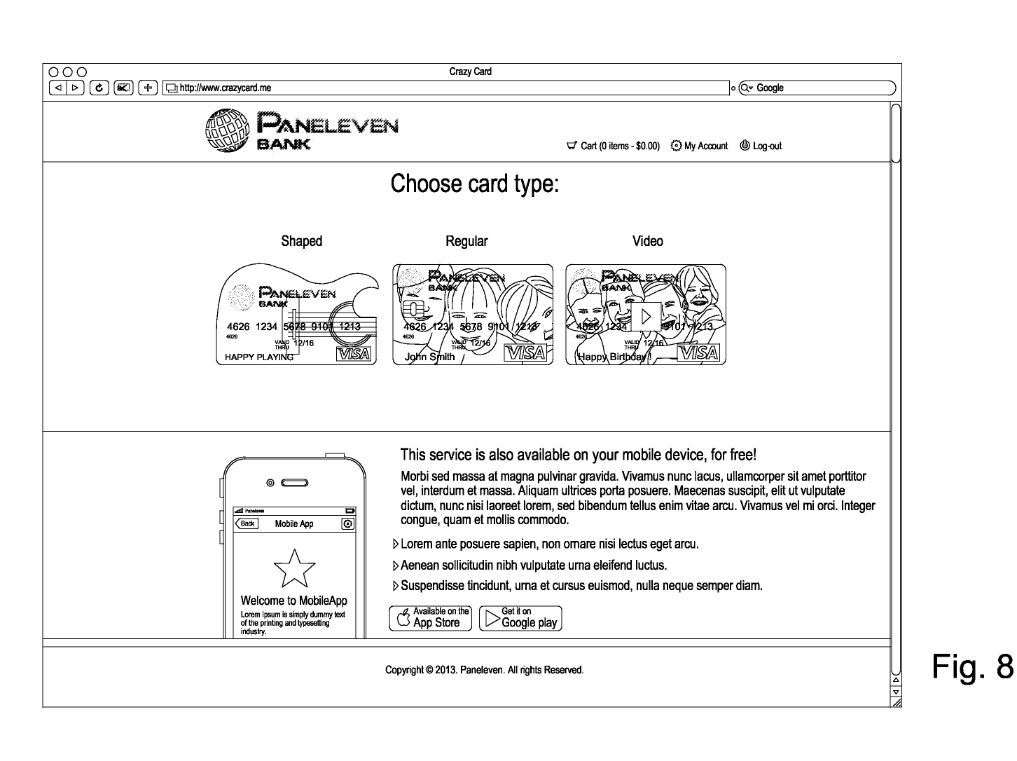

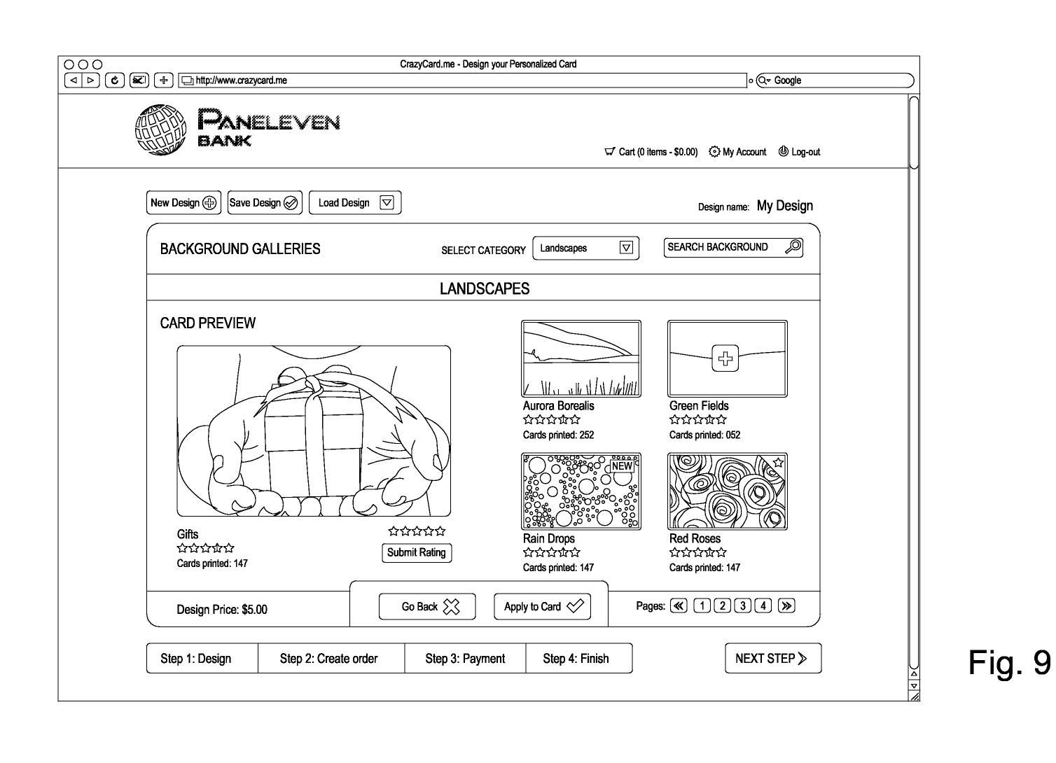

The user then selects whether they wish to produce an image card, or a video card (step S40). At this point the user may also decide if they wish to design a special shaped card as shown in FIG. 8.

If a special shape card has been selected the user then determined the shape for the card (step S41). This applies to both image and video cards. A number of predefined shapes for cards are provided by the system, which the user can select from. While in some applications, in particular for certain financial transaction cards only one standard shape may be provided, for gift cards and other suitable applications alternative shaped cards may be provided. Hence, in some applications this step will be excluded.

This process for image and video cards now differs and therefore the production of an image card shall firstly be discussed.

The user then selects an image and can decide whether they wish to upload, capture, or pick from a range of hosted images for the image to be produced on a card (step S42). FIG. 9 provides a screen shot of how a user may choose a picture from a range of hosted images. A user is able to upload an image in any suitable picture format such as .jpg, .png, .tiff, and .bmp, that may be located on their desktop computer or a remote server.

When capturing an image a camera linked to the user device (either as a peripheral or integrated device) is utilised. The image capturing process is based on a Flash plugin that is embedded into the HTML5+JavaScript webpage that provides the user interface. The user is therefore able to capture an image directly from his/her camera. The image is then stored on the user device for editing.

Once the desired image and card shape are selected, the image is automatically scaled to fit the pre-defined dimensions of the card (step S43). The image is then presented on the browser-based interface on top of a pre-defined card design area. Artificial intelligence is used to examine the selected image and represent the best format for the card to the user without reducing the resolution of the image. To be more specific, the solution looks at the aspect ratio of the image and immediately provides to the user the “best fit” size. Furthermore, a maximum scaling option is presented to the user, after which the quality of the image becomes compromised in terms of the card printing equipment. This maximum will be determined based on the card printing equipment used for a particular application.

While the selected image may be the background for the card, it is also possible for the selected image to be placed on a background colour or image on the card. The user may pick from multiple background colours and/or background images for their image to be positioned on.

The pre-defined card design area displayed on the user browser-based interface is provided in a template form. Some features on the card template may be provided due to financial institutions and scheme requirements such as the banks logo, Visa logo, Hologram, and chip position. Hence, these areas are represented so that the user can see where their image will not be seen when the card is printed. The template will be imported and/or defined dependent on the card to be personalised, and this template can therefore be obtained as soon as the card type is selected.

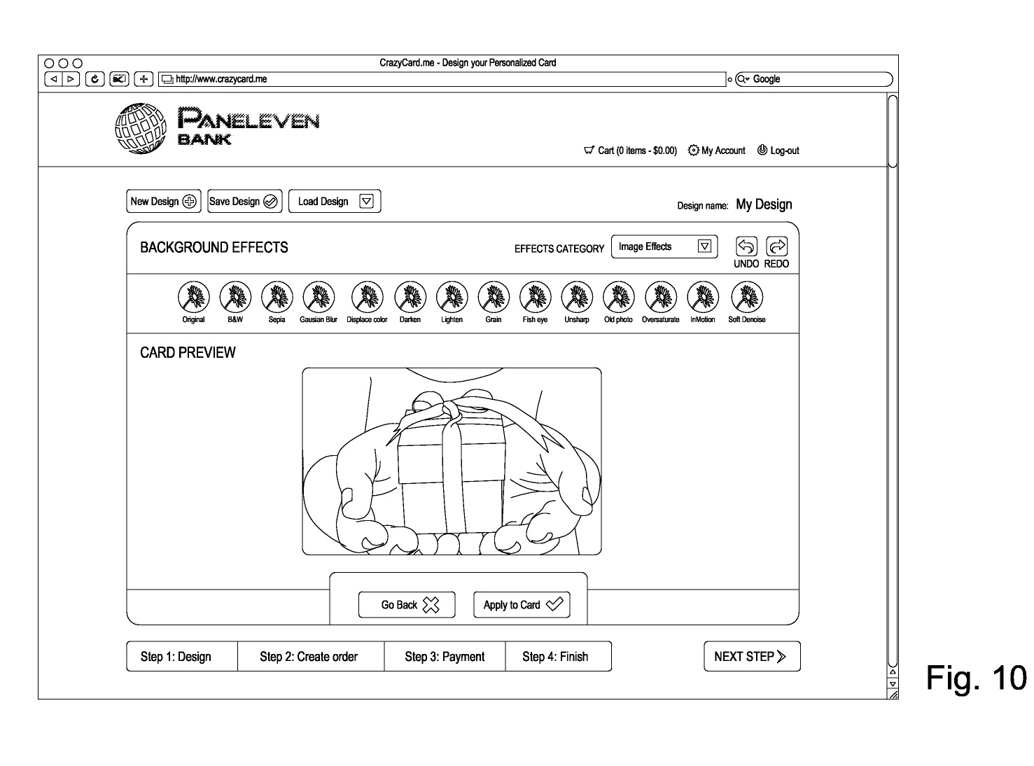

Following the scaling of the image, the user is able to apply manipulations to the image (step S44). The manipulations comprise: editing of the image, for example transformations such as, rotation, mirroring, and scaling; applying effect to the image, such as converting the image to B&W, Sepia effect, “Polaroid” effect, or choosing gradients; adding layers on top of the image, for example by adding another image, which can be another upload/capture, upload of a selection from a set of pre-defined images such as frames or stickers. FIG. 10 shows a user interface in which a user is able to apply one of a plurality of different effects to an image.

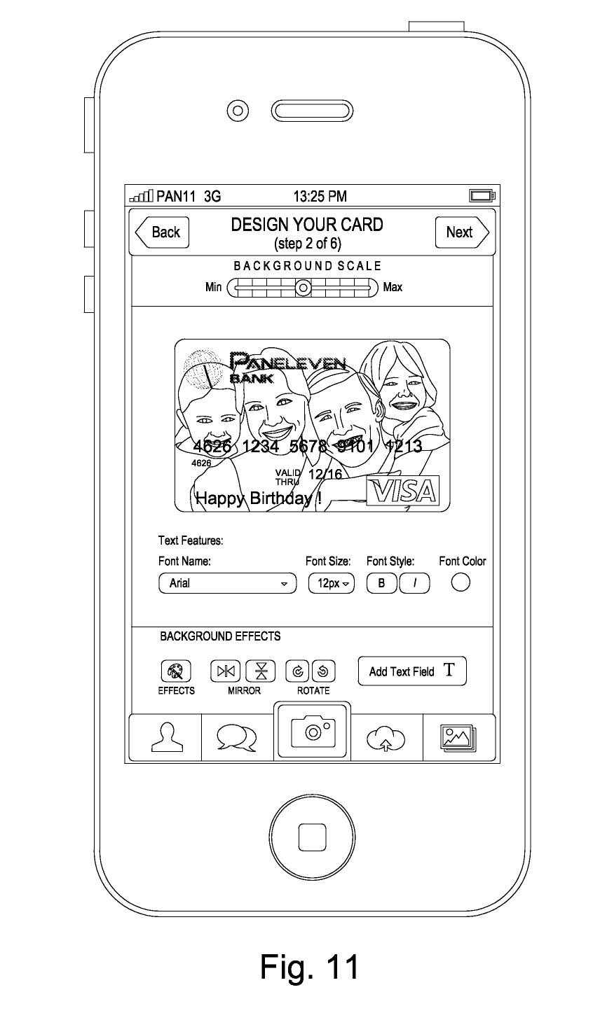

The card designing functionality also supports adding of text fields. The text fields are divided into 2 types: (1) A classic text field, such as those used in any and all image editing tools; and (2) Emboss/Indent text fields. Text fields are programmed to be editable to allow users to recycle the manipulated images and simply change the text field if required. This is possible using j Query libraries for creating draggable and resizable elements. The classic text fields are embedded in the resulting final output image. The user is able to edit the text, for example by changing the font, size, and/or colour, and edit the text field, for example by rotating the text field, if the classical text fields are used. Once the user has finished inserting the designer text, and applied all the required manipulations, the text field is embedded and becomes part of the design. FIG. 11, shows a service provider's app being used to add text to an image.

Embossed/Indented text is usually applied to pre-paid cards. Furthermore, the embossed text can only be used on specific types of pre-paid cards and only if the text is accepted by the card issuer and the text is the same size and font as other emboss/indent text present on the card, namely Standard Gothic 10cpi font and OCRB1 10cpi font.

During the editing process the user is able to obtain a 360° preview of the card (step S45). The user is presented with a window where a script changes the perspective of the card depending on the rotation angle selected by the user.

Once the user has finished editing their image it can be saved on the user device. Then, as part of the ordering process that has already been described, the image along with the information regarding the manipulations and editing that has taken place can be sent to the service provider server 300 to be stored in memory associated with the user account.

As mentioned previously, the user is also able to select production of a video card, rather than just a personalised image card. As an overview, the video card system works using augmented reality (AR) which is a live, direct or indirect, view of a physical, real-world environment whose elements are augmented by computer-generated sensory input such as sound, video, graphics or GPS data. As a result, the technology functions not only by enhancing one's current perception of reality but the information about the surrounding real world of the user becomes interactive and digitally manipulable. That is, artificial information about the environment and its objects can be overlaid on the real world.

In the present system the video card allows for a video to be perceived as being present on the surface of the card if the card is viewed through a mobile device using the service provider's app or such like, as will be discussed in more detail. This is achieved by printing an image on the card as a video tag, such as the first frame of the video (even though it will be appreciated that other tags could be utilised), which a user device such as a mobile phone is able to identify. When a user device recognises the image it finds, in the service provider's server, a video associated with the image and overlays this image on the card when the card is viewed through the user device. The user therefore sees the video being played as if it is on, or at least in some way associated with, the card.

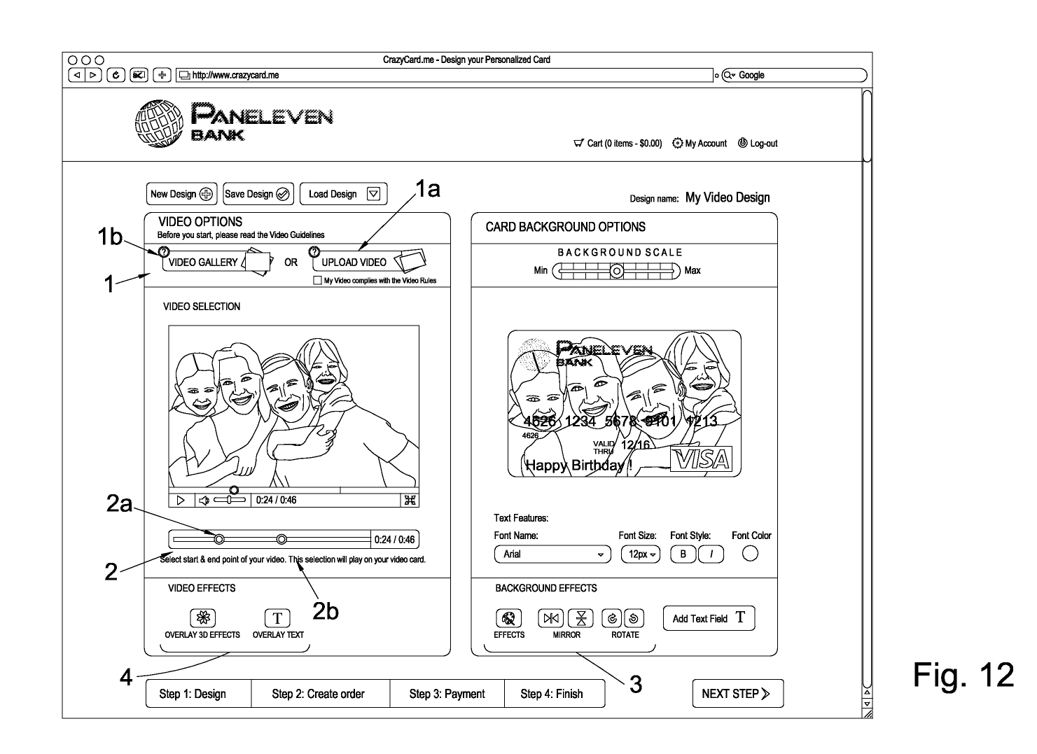

The video card design process is now described with reference to FIG. 12, along with the steps of FIG. 7. FIG. 12 shows the user interface screen used by a user to produce the image and video for the video card.

If the user selects that they wish to produce a video card, they will firstly have to select a video for the card (step S46), as shown by reference numeral 1 in FIG. 12. As with the image selection, the user is able to capture the image using an image capture device, or upload the image from internal or remote memory 1a, or select from the gallery of videos, 1b.

The system firstly checks the quality of the video by measuring the resolution of the video (step S47). If the video quality is not high enough to (a) produce an image to be printed, and (b) to produce a video that can be watched when displayed as if on the card (e.g. the measured resolution is less than a minimum resolution for providing a certain standard of picture quality), then the user will be prompted to upload another video and/or (subject to card issuer requirements) be allowed to continue with the process, only if they have acknowledged that the produced card will not be of a high quality.

The system comprises an automatic conversion tool that converts the user captured and/or uploaded video format to any or all other video formats (step S48). This process is required because of the differences in which HTML5 video API is implemented in different internet browsers such as Internet Explorer, Chrome, Firefox, Opera, and Safari and/or the older versions of those browsers, for example Internet Explorer 8 or Internet Explorer 9. Once the video is successfully converted into the required video, it is displayed to the user.

The system comprises a video range selection function 2, which allows the user to select the range of the video, i.e. the frame position at which the video starts, 2a, and the frame position at which the video ends, 2b, (step S49). The starting position of the video 2a, i.e. the user selected first frame, is replicated in real time to the card template canvas, which displays the first frame as a static background image on the card, i.e. the image that will be printed on the card (step S50). However, in alternative systems the image to be printed on the card could be any frame of the video, or any other image selected by the user that may not relate to the video. Whatever image the user selects for printing on the card the user is able to edit that image. As such, the user is directed to the process starting at step S43 to personalise the image. In the example of FIG. 12, the left hand side of the screen shows a video editing functionality, while the right hand side of the screen shows an image editing functionality. It can be seen that the user has selected the first frame of the video to be printed on their card.

Once the user has chosen the image to be printed on the card, the user is able to edit that image in the various ways discussed in respect of the standard image-based card (step S51), 3. Video editing, 4, functionality that enables the user to add special effects such as text overlay and transitions is also provided in some versions of the system.

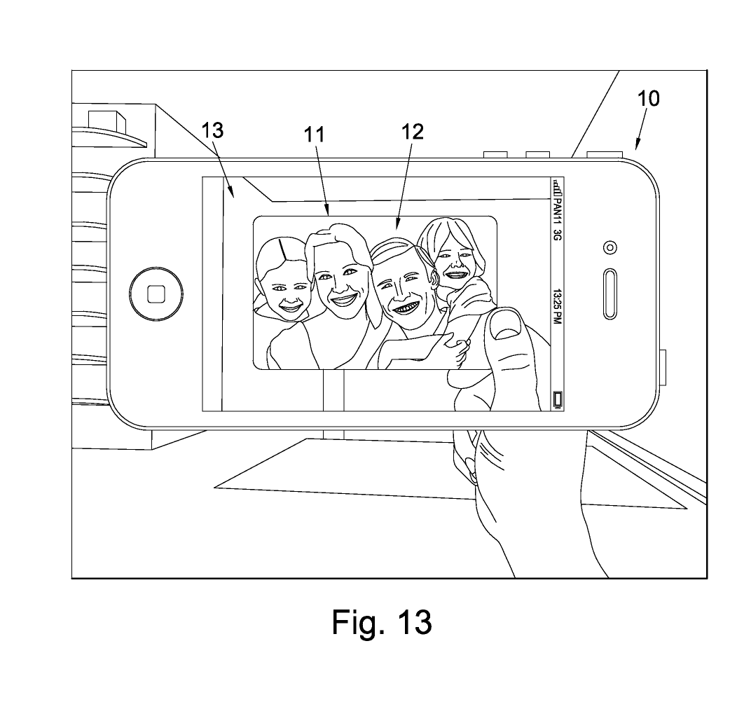

As with a standard image personalised card, a video card also allows for a preview functionality prior to confirming the purchase of the card (step S52), which is shown in FIG. 13. The user opens the preview screen and a camera associated with the user device 10 is turned on. The user then puts any card 11 in front of the camera, and the AR software recognises the shape of the card and then tracks the position of the recognised card. The proposed design and video is then overlaid 12 on the card in the user device display 13. Such a system does not require the card to be printed, but simply recognises the shape of any card in order to demonstrate the AR functionality and expected look/results. This AR functionality could also be utilised for previewing an image card.

Once the user has finished manipulating the image and/or video, the user is prompted to “save” or “save as” the card design. The user may apply a user defined name such as “skiing holiday card”. The finalised image for printing on the card, along with the associated video and manipulations can then be transmitted to and stored on the service provider server 300.

Following saving of the video, manipulations and image, the user is prompted to perform the payment operation. This procedure is the same as that described for the standard image-based card. The video card is therefore ordered, processed, and delivered to a recipient, who may be the purchaser for a debit/credit card.

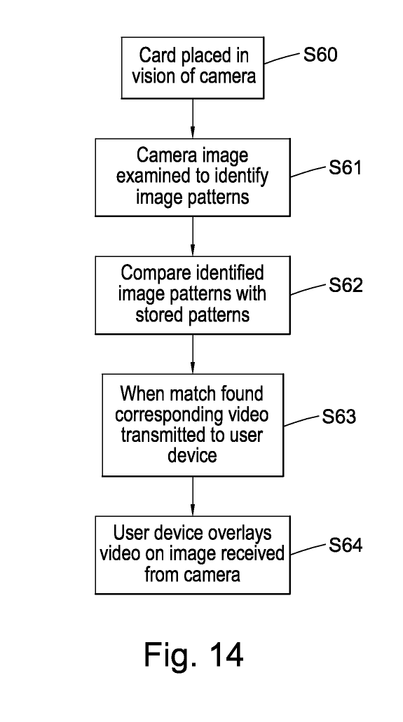

When the recipient receives the video card the video functionality of the video/AR card can be used as described in detail below and shown in FIG. 14.

The user or recipient places the card in the view of an image capture device such as a camera of the user device used for reading the card (step S60). A recognition system is then used to recognise the card and perform a matching process. Once a match is made (between the card and the video), the user device either intakes a video stream or downloads the video, is in view of the camera. The card image is examined using a processor of the user device in order to attempt to identify unique features in the image being examined, such as the image itself or other recognition elements such as the PAN or an MRD (step S61). The processor uses a particular processing methodology forming part of the mobile app, which is stored on the user device. If the card image is used as an identifying unique feature, and since the image consists of pixels and pixels are interpreted as a series of numbers, the image recognition system detects these patterns. Once a suitable pattern has been recognised this recognised pattern is transmitted from the user device over a network to the service provider server. The service provider server then compares the received image pattern information and compares this with images stored in its database (step S62). Once the server finds a match, the server then obtains the video associated with the image and transmits this image to the user device (step S63). The user device then displays the video overlaid on the card in the output image of the user device screen (step S64). Consequently, it looks as if the video is being played on, or around, the card itself. The image is tracked in space using AR SDK and the position of the AR overlay is adjusted according to personalized card position. For non-standard shaped cards, the mobile device is able to detect the borders of the object (i.e. the card), so that it can determine the exact shape on which the AR content would be displayed. Consequently, the video can be displayed within the borders of the physical card.

In alternative systems, instead of recognising the image that is printed on the card, a Machine Readable Device (MRD), such as a QR code or barcode, is also printed on the card and the MRD is recognised by the user device for retrieval and overlaying of the video. The process involves either an “on the fly” MRD generation or utilisation of a pre-produced MRD. In both cases, the MRD is embedded into the card design as a static element of the overall image, following the approval of the image/video phase. The MRD may be provided on the template provided to the user so that they can factor the presence of the MRD into their design. The MRD may be invisible to the naked eye by being printed in an ‘invisible colour’ such as infrared, or using steganography techniques which hide the MRD within the user selected image to be printed on the card.

In yet further alternative systems Near Field Communication (NFC) recognition is utilised. The mobile device receives a unique identification due to the NFC, which can then be used to obtain the video from the server in a similar way to other systems disclosed herein.

In the case of NFC, the initial matching of NFC chip is carried out during the personalisation of the card at the CPB. During the personalisation process, the CPBs equipment reads the serial number associated with the NFC chip and transfers it back to the service provider under the same unique identifier that was used for the user image. The service provider then associates chip number to the image and video. It will be appreciated that the CPB could encode the uID to the NFC tag so that the CPB need not send the chip serial number back to the service provider's system.

The system also comprises means for providing a card carrier template to the CPB, which contains a QR code containing a URL address that takes the user to the relevant native application store (ITunes, Google Play) and allows them to download the application necessary to use the video functionality. In addition, the card carrier may contain a border which is necessary for some AR training tool systems. This border allows the AR recognition element component to detect the borders of the object (i.e. the card), so that it can determine the exact shape on which the AR content would be displayed. This functionality is particularly useful when a non-standard card shape is selected.

It will be appreciated that the augmented reality system need not provide an overlaid video, but could instead provide an overlaid image.

In other systems, rather than video being transmitted in response to recognition of a marker, audio is transmitted. In such systems, the user may be presented with the choice of selecting an image card, a video card, or an audio card. If the user selects the audio card option, he will be presented with a card designer tool (either standard shape or special shape), with the additional option for the user to select an audio file that will play when the card is recognised by a recipient's device. A stock of audio files is provided by the service provider system, including a “preview” function, which limits the audio to a limited period preview, such as 30 seconds. The user also has the option to upload an audio file from its computer or to record the audio directly from a microphone associated with the user device. For example, an Adobe Flash plugin may be integrated into the service provider's user interface in order to provide access the user device's microphone to record audio from the user's device. After the user has selected the audio that will play, the card designing process finishes, and the card order is created. The ordering procedure is the same as with image/video cards, including the approval process.

In order to properly identify the audio file associated to the card printed, the service provider system is able to use any of the various procedures discussed above regarding video cards, that is by associating the card to an account stored in the service provider's memory using an identification method such as image recognition, MRD or NFC recognition.

As with a video card, the user of the card recognises the card using which ever recognition technique being utilised and upon recognition of the card and association of the card with an audio file, the audio is either streamed to or downloaded by the user device, subject to the system set-up (for example, a 30 second “preview” audio may be streamed).

The user may be provided with an option to purchase the audio associated with the card after the first play, if the audio has been downloaded, or after the 30 second preview if the audio is streamed. The payment application of the app or website via which the user of the card is accessing the audio will then perform the audio purchasing transaction and/or the service provider will link to 3rd party systems such as iTunes and Apple ID to complete the purchase process.

In certain alternative systems, the audio associated with the card may not be selected by the user when creating the personalised card, but may be added by the service provider on behalf of the card issuer, or by the card issuer if the card issuer is providing the service provider functionality. For example, if the card issuer is issuing a gift card for an online music store then an audio file may be added to try to tempt the recipient of the card to buy a particular song or album. It is envisaged that the audio associated with the card could provide other types of advertising. In alternative systems, the video functionality associated to the card by the service provider or card issuer for advertising purposes or such like.

It will be appreciated that the audio card functionality could be used for both financial transaction cards and pre-paid cards, even though the number of applications in the pre-paid card market may be greater.

### Optical Character Recognition (OCR)

In an embodiment of the invention OCR is utilised in order to speed up the credit card saving procedure. OCR is used to recognize the credit card number the user wants to use for online payment. A camera of a user device takes a picture of a credit or debit card in the field of vision of the camera. The OCR function reads the data embossed on the card. For example, the OCR function reads the Personal Account Number (PAN) which is the long 16-digit number printed on any credit or debit card, valid from/to dates, issue number (if applicable), and/or cardholder name.

The OCR function then carries out a fraud check. The first 6 digits of the PAN are used to verify that the card is not fraudulent. From the first 6 digits of the PAN the type of card (e.g. Visa/MasterCard), the issuing bank (e.g. RBS, Lloyds), and the type of product (e.g. Visa Debit, MasterCard Gold) can be determined. The OCR function of the system therefore uses image recognition to verify that all of the logos associated with the card are present on the card that should be given the type of card identified by the PAN, and that these logos are in their correct positions. Such bank predefined card templates are accessed from a database. In addition, the system is able to examine the background of a card to ensure that the card is not printed on blank white plastic, which would be indicative of a fraudulent card. Some or all of the above mentioned verification procedures may be implemented, subject to the requirements of the card issuer. In the case of Amex cards, where the CVV2 number is printed on the front of the card and which may never be stored (PCI compliance regulation), the system is able to block recording an image of a particular section of a card where this CVV2 number is printed on Amex cards so that this section of the card is not scanned during the OCR procedure. This OCR function also uses several algorithms such as the Luhn algorithm to validate the PAN number and checks for any errors during scanning.

After the security checks have been carried out and it is determined that the card is valid, the PAN is obtained and automatically entered into the payment system provided by the interface running on the user device. This information can then be used for processing of the payment.

The OCR function uses a matrix matching technique for character recognition, and in particular a pattern matching technique which compares the received image with stored bitmapped patterns representing characters. Alternative matching techniques that do not use predefined pattern matching techniques may be used. When using such techniques, elements such as closed forms, lines, intersections, and closed paths, may be searched for.

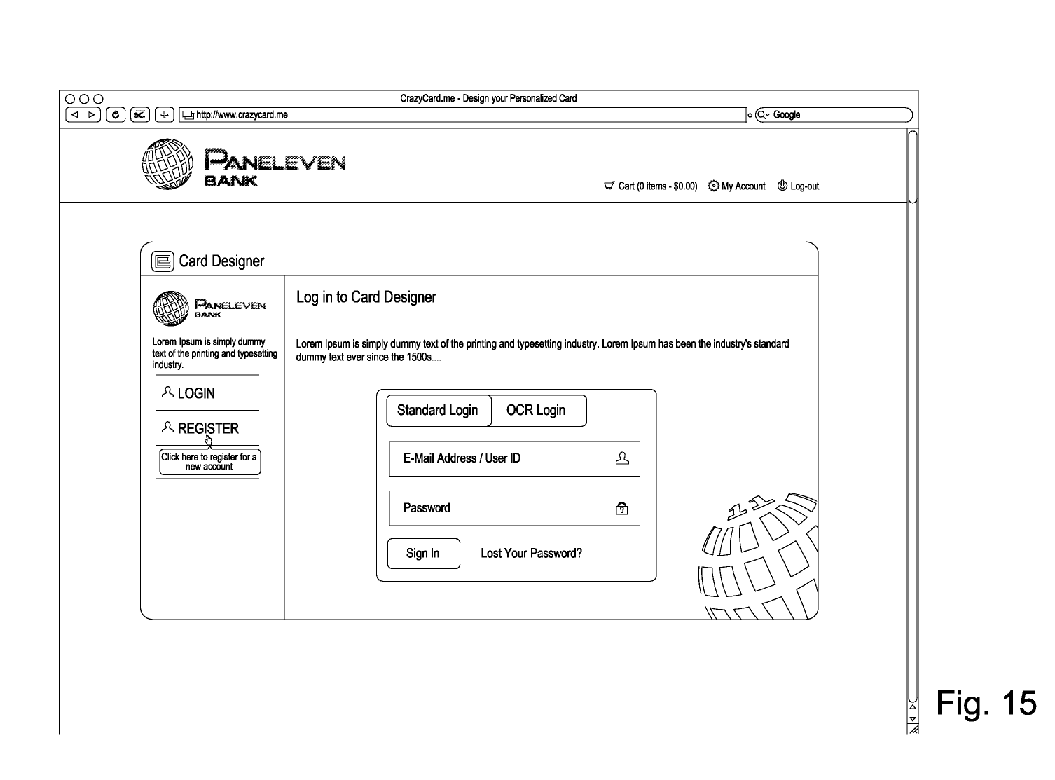

It will be appreciated that this payment scheme has applications in any online payment mechanism. Furthermore, the OCR functionality can also be used a means for logging into a system or for any other verification application. FIG. 15, provides an example of an OCR login screen for the system described above. For example, if the user already has a profile stored including their associated credit or debit card details, then scanning the PAN will automatically log the user into the system. Furthermore, the OCR functionality could be utilized for identifying a video card in accordance with the video card system discussed above. In other systems, the OCR functionality could be used for card activation purposes. It will be appreciated that the log-in functionality is applicable to logging into any system.

In an alternative system, the whole or a part of the system functionality is provided within a kiosk. In one case, a booth is provided in a bank or store in place of the user device in the systems described above. The card could therefore be automatically printed and presented to the user instantly. In an alternative system, data is still stored on the service provider's server and therefore only the user device and CPB printing functionality is provided at the kiosk. In yet another alternative system, only the user device functionality is provided at the kiosk. The card designing functionality could be provided at the kiosk, or could be performed elsewhere and then the kiosk is used for verification and printing. In instant issuance systems the images available are limited to previously approved images from in a user account or stock images.

It will be appreciated that in alternative embodiments of the invention not all of the functionalities described in the systems above need be provided in a single system. For example, in alternative embodiments a system is provided that only provides financial transaction cards, and another system is provided that only provides pre-paid cards.

In other alternative embodiments the bank hosts the system functionality. For example, the bank is the service provider and therefore provides the service provider functionalities. Consequently, the security provisions provided for communications between the service provider and bank are not required because these communications are internal communications. It will also be appreciated that the CPB functionality could be provided by the bank.

It will be appreciated that the servers described herein comprise a processing unit, a memory, and a communication unit. The functionality of the server may be provided at a single location or distributed across a network.

It will be appreciated that the various steps described in the various procedures need not necessarily take place in the order described. For example, the order that the user decide whether to make an image or video card, make a standard shape or special shape card is not of particular importance, even though a certain order may seem more logical.

The various methods described above may be implemented by a computer program product. The computer program product may include computer code arranged to instruct a computer to perform the functions of one or more of the various methods described above. The computer program product and/or the code for performing such methods may be provided to an apparatus, such as a computer, on a computer readable medium. The computer readable medium could be, for example, an electronic, magnetic, optical, electromagnetic, infrared, or semiconductor system, or a propagation medium for data transmission, for example for downloading the code over the Internet. Hence, the computer readable medium may be a downloadable computer program, native application, or app. As such, the code could be provided as part of a website accessed by a computer, the website arranged to instruct the computer perform one or more of the various methods described above. Non-limiting examples of a physical computer readable medium include semiconductor or solid state memory, magnetic tape, a removable computer diskette, a random access memory (RAM), a read-only memory (ROM), a rigid magnetic disc, and an optical disk, such as a CD-ROM, CD-R/W or DVD. The computer may be a smart phone, a laptop computer, a server, or any other device having computing functionalities, such as a processor to perform the method and a memory to store information necessary to perform the method.

1. A method for producing a personalised image for printing on a financial card, the method comprising:
receiving, through a user interface of a user device, instructions to manipulate an image for printing on a financial card, the image being stored on the user device;
processing, at the user device, the image in accordance with the manipulation instructions; and
sending the manipulated image from the user device to a service provider for printing the manipulated image onto a financial card.

2. The method according to claim 1, further comprising receiving the image at the user device and storing the image on the user device prior to receiving manipulation instructions from the user.

3. The method according to claim 2, wherein the image is received from an image capture device associated with the user device.

4. The method according to any one of claims 1 to 3, further comprising displaying the image on a display of the user device, wherein the display forms part of the user interface.

5. The method according to any preceding claim, further comprising sending, with the manipulated image, information identifying a user associated with the user device when sending the manipulated image from the user device to the service provider.

6. The method according to claim 5, further comprising obtaining the information identifying the user.

7. The method according to claim 6, wherein the information identifying the user is obtained using a login process.

8. The method according to claim 6, wherein the information identifying the user is obtained by scanning a financial card associated with the user.

9. The method according to claim 8, wherein the information identifying the user is identified from the scanned financial card using optical character recognition.

10. The method according to claim 8, wherein the information identifying the user is obtained using near field communication NFC.

11. The method according to any preceding claim, further comprising sending information identifying the manipulations applied to the image for forming the manipulated image with the manipulated image.

12. The method according to any preceding claim, wherein the image is a frame of a video and the manipulations are manipulations to the video.

13. The method according to claim 12, wherein the method further comprises:
receiving the video prior to receiving the instructions to manipulate the image;
analysing the quality of the video; and
informing the user of the quality of the video when the quality of the video is deemed to be below a threshold quality level.

14. The method according to claim 12 or claim 13, wherein the step of sending the manipulated image from the user device to a service provider further comprises sending the video with the image.

15. The method according to claim 12 or 13, wherein in the step of sending the manipulated image from the user device to a service provider, the manipulated image is a frame of the video and the video is sent from the user device to the service provider.

16. The method according to claim 15, wherein the frame of the video forming the manipulated image for printing on the financial card is identified in metadata associated with the video.

17. The method according to any preceding claim, wherein the method further comprises associating audio with the image at the user device and sending the audio with the manipulated image to the service provider.

18. Apparatus for producing a personalised image for printing on a financial card, the apparatus operable in use to perform the method of any one of claims 1 to 17.

19. The apparatus according to claim 18, wherein the apparatus is a user device.

20. A computer program product operable, in use, to instruct a computer to perform the method of any one of claims 1 to 17.

21. A computer readable medium arranged to be utilised by a computer to instruct a computer to perform the method of any one of claims 1 to 17.

22. A website accessible by a computer and operable, in use, to instruct a computer to perform the method of any one of claims 1 to 17.

23. Apparatus for creating a personalised financial card, the apparatus comprising:
a processor arranged to perform the method of any one of claims 1 to 17; and
a printer arranged to print the manipulated image onto a card.

24. The apparatus according to claim 23, further comprising a communication unit arranged to obtain information associated with the user for printing onto the card.

25. A method for managing the production of a personalised financial card, the method comprising:
providing, from a server associated with a service provider, computer operable instructions to a user device, the computer operable instructions arranged to enable a personalised financial card to be designed at the user device;
receiving, at the server associated with the service provider, an image for printing on a personalised financial card from the user device; and
storing the manipulated image at the server.

26. The method according to claim 25, wherein the computer operable instructions provided to the user device are arranged to instruct the user device to perform the method of any one of claims 1 to 17.

27. The method according to claim 25 or claim 26, further comprising:
receiving, at the server associated with the service provider, a request to access a financial card personalisation website hosted by the service provider, and providing access to the website responsive to receipt of the request, wherein the website includes the computer operable instructions.

28. The method according to any one of claims 25 to 27, further comprising:
transmitting, from the server to a printing facility for a personalised financial card, the manipulated image along with a unique reference identifying a user associated with the manipulated image, wherein the printing facility identifies, from the unique reference, information associated with the user for printing on the personalised financial card.

29. The method according to claim 28, wherein the unique reference is used as the file name for the manipulated image for transmission to the printing facility.

30. The method according to claim 28 or claim 29, wherein the service provider obtains the unique reference from a card issuer.

31. The method according to claim 28 or claim 29, wherein the service provider creates the unique reference and transmits the unique reference to a card issuer.

32. The method according to claim 30 or claim 31, wherein the financial card is a financial transaction card and the card issuer is a bank.

33. The method according to claims 28 to 32, wherein the printing facility obtains the information associated with the user for printing on the personalised financial card from the unique reference in accordance with information received at the printing facility.

34. The method according to claim 33, wherein the information received at the printing facility for obtaining the information associated with the user for printing on the personalised financial card from the unique reference is a conversion tool for converting the unique reference into the information associated with the user.

35. The method according to claim 25 or claim 26, wherein the manipulated image is converted to a card personalisation form prior to being transmitted from the service provider to a card issuer, the card personalisation form providing the manipulated image in a format for inclusion of the manipulated image within a card personalisation file.

36. The method according to claim 35, wherein the card personalisation form is a binary data stream.

37. The method according to claim 35, wherein the card personalisation form is a URL providing a means for obtaining the image from a stored location.

38. The method according to any one of claims 25 to 37, wherein the service provider associates media content with the manipulated image stored in the server, the media content arranged to be accessible to a device responsive to a request from a device including an identification associated with the manipulated image.

39. The method according to claim 34, wherein the media content is one or more of an image, a video or audio.

40. The method according to one of claim 37 or 38, wherein the media content is supplied to the service provider by a card issuer.

41. A server for managing the production of a personalised financial card, the server arranged to perform the method of any of one of claims 25 to 40.

42. A method for managing processing of a personalised financial card, the method comprising:
receiving, at a server of a personalised financial card service provider, a request from a user device to access a financial card personalisation website hosted by the server;
determining, from the received request, the Internet browser being used by the user device from which the request was sent;
determining whether the determined Internet browser associated with the user device provides functionality capable of instructing the user device to process an image in accordance with manipulations input by a user at the user device;
providing access to a website hosted by the server that enables the image to be processed on the user device, if the browser provides functionality capable of instructing the user device to process the image; and
providing access to a website hosted by the server that enables the user to select manipulations to be made to the image and sends these manipulations to the server for processing, if the browser does not provide functionality capable of instructing the user device to process the image.

43. The method according to claim 42, further comprising determining whether the Internet browser is capable of instructing the user device to process the image by comparing the determined Internet browser with a database listing Internet browsers capable of instructing a user device to process an image.

44. The method according to claim 42 or claim 43, wherein if the browser does not provide functionality capable of instructing the user device to process the image, the method further comprises:
receiving, from the user device, an image selected by the user;
receiving, from the user device, information indicative of manipulations to be made to the image; and
manipulating the image at the server in accordance with the received manipulations.

45. The method according to claim 43, wherein when the browser provides functionality capable of instructing the user device to process the image, the website that the user device is provided with access to is arranged to instruct a computer to perform the method of any one of claims 1 to 17.

46. The method according to any one of claims 42 to 45, wherein the internet browser type is determined by a PHP get_browser method or JavaScript navigator object.

47. A server for managing processing of a personalised financial card, the server arranged to perform the method of any one of claims 42 to 46.

48. A method for providing additional media content associated with a financial card, the method comprising:
identifying a financial card at a user device;
obtaining, at the user device, additional media content associated with the financial card from a remote server; and
outputting the additional media content through an output of the user device.

49. The method according to claim 48, wherein the financial card is identified using near field communication.

50. The method according to claim 48 or 49, wherein the financial card is identified by analysing an image received from an image capture device of the user device.

51. The method according to claim 50, wherein the financial card is identified by identifying an image on the financial card in the image received from the image capture device.

52. The method according to claim 51, wherein the image on the financial card is a card background image.

53. The method according to claim 51, wherein the image on the financial card is a PAN number.

54. The method according to claim 53, wherein the PAN is identified using optical character recognition.

55. The method according to claim 51, wherein the image on the card is a machine readable device, MRD.

56. The method according to claim 55, wherein the MRD is hidden within a card background image.

57. The method according to any one of claims 50 to 56, wherein the financial card is identified by identifying patterns in the received images and comparing the identified patterns with patterns stored in memory indicative of features of a financial card, wherein information identifying the financial card is obtained from a result of the comparison.

58. The method according to any one of claims 48 to 57, wherein the additional media is obtained by sending information identifying the financial card to a server and receiving the additional media responsively.

59. The method according to any one of claims 48 to 58, wherein the additional media content is audio and the outputting of the media content comprises playing the audio through a speaker of the user device.

60. The method according to any one of claims 48 to 58, wherein the additional media content comprises an image and the outputting of the media content comprises displaying the image on a display of the user device.

61. The method according to claim 61, wherein the obtained additional image is a video or forms a part of a video.

62. The method according to claim 60 or claim 61, further comprising:
receiving an image from an image capture device of the user device, the image capture device having a field of view;
determining a position of the financial card in the image received from the image capture device;
overlaying the obtained image on the image received from the image capture device to create an augmented reality image, the overlaid image being positioned according to the determined position of the financial card; and
displaying the augmented reality image on the display.

63. The method according to claim 62, wherein the overlaid additional image is positioned at the determined position of the financial card in the image received from the image capture device in real time.

64. The method according to claim 62 or claim 62, wherein the position of the financial card is determined in accordance with a template identifying an outline shape of the financial card.

65. The method according to claim 62 or claim 63, wherein the position of the financial card is determined from the position of the image on the financial card in the received image.

66. The method according to claim 62 or claim 63, wherein the position of the financial card is determined using edge recognition.

67. The method according to claim 62 or claim 63, wherein the position of the financial card is determined using AR SDK.

68. Apparatus for providing additional media content associated with a financial card, the apparatus operable in use to perform the method of any one of claims 48 to 67.

69. The apparatus according to claim 68, wherein the apparatus is a user device.

70. A computer program product operable, in use, to instruct a computer to perform the method of any one of claims 48 to 67.

71. A computer readable medium arranged to be utilised by a computer to instruct a computer to perform the method of any one of claims 48 to 67.

72. A website accessible by a computer and operable, in use, to instruct a computer to perform the method of any one of claims 48 to 67.

73. A method for managing the providing of additional media content associated with a financial card, the method comprising:
providing, from a server associated with a service provider, computer operable instructions to a user device, the computer operable instructions for instructing the user device to perform the method of any one of claims 48 to 67.

74. The method according to claim 73, further comprising:
receiving information identifying a financial card from the user device;
identifying an additional image associated with the identified financial card; and
sending the additional image information to the user device.

75. A server for managing the providing of additional media content associated with a financial card, the server arranged to perform the method of claim 73 or claim 74.

76. A method for user verification, the method comprising:
receiving an image from an image capture device having a field of view;
analysing the image received from the image capture device to identify a Personal Account Number, PAN, associated with a financial transaction card within the field of view of the image capture device;
determining a type of card from the PAN;
obtaining information indicative of characterising features associated with the determined type of card;
analysing the image received from the image capture device to identify the presence of at least one characterising feature associated with the type of card on the financial transaction card within the field of view of the image capture device;
outputting a positive verification signal if the characterising features are identified.

77. The method according to claim 76, wherein the type of card is determined from the PAN.

78. The method according to claim 76 or claim 77, wherein identifying the presence of the at least one characterising feature comprises determining whether an object matching one of the at least one characterising feature is on the card and determining whether the object matching the at least one characterising feature is in the correct position on the card.

79. The method according to any one of claims 76 to 78, wherein the at least one characterising feature includes one or more of a name, a valid from date, an expiry date, and a logo.

80. The method according to any one of claims 76 to 79, further comprising logging into a system responsive to the positive verification signal.

81. The method according to any one of claims 76 to 79, further comprising using the identified PAN for a payment responsive to a positive verification signal.

82. The method according to any one of claims 76 to 81, wherein the PAN is identified using an optical character recognition, OCR, scheme.

83. The method according to claim 82, wherein the OCR scheme is a matrix matching technique for character recognition that comprises determining one or more patterns in the received image and comparing the one or more determined patterns with patterns stored in memory.

84. Apparatus for user verification, the apparatus operable in use to perform the method of any one of claims 76 to 83.

85. A computer program product operable, in use, to instruct a computer to perform the method of any one of claims 76 to 83.

86. A computer readable medium arranged to be utilised by a computer to instruct a computer to perform the method of any one of claims 76 to 83.

87. A website accessible by a computer and operable, in use, to instruct a computer to perform the method of any one of claims 76 to 83.
